(19) United States
(12) Patent Application Publication
(10) Pub. No.: US 2003/0192407 A1
(43) Pub. Date: Oct. 16, 2003

(54) Spanner

(76) Inventor: Wen-Hsien Chen, Taichung (TW)

Correspondence Address: Wen-Hsien Chen, 58, MA YUAN WEST ST., TAICHUNG, TW

(21) Appl. No.: 10/124,699

(22) Filed: Apr. 10, 2002

(51) Int. Cl. B25B 13/46

(52) U.S. Cl. 81/60

(57) ABSTRACT

A spanner has a handle bar, a box head disposed on the handle bar, a ratchet ring, a C-shaped retainer, a spring, and a serrated block. The box head has an arc-shaped guide wall, an inner aperture, and an inner groove. The ratchet ring has a plurality of ratchet teeth. The serrated block has a plurality of ratchet serrations, an arc-shaped blocking face, and a blind hole. The serrated block is inserted in the inner groove of the box head. The spring has a first end inserted in the blind hole of the serrated block, and a second end inserted in the inner aperture of the box head. The C-shaped retainer surrounds the ratchet ring. The ratchet ring is inserted in the box head to be engaged with the serrated block.

### BACKGROUND OF THE INVENTION

The present invention relates to a spanner. More particularly, the present invention relates to a spanner which increases a rotational torsion of the spanner.

Referring to FIG. 6, a conventional spanner 10′ has a box head 11′ having a transverse hole 41′ and a blind hole 46′ communicating with the transverse hole 41′, a spring 43′ and a ball 44′ inserted in the blind hole 46′, a ratchet ring 20′ inserted in the box head 11′, a ratchet block 40′ inserted in the transverse hole 41′, an adjustment plate 42′ connected to the ratchet block 40′, and the ratchet block 40′ having a slant groove 45′. The ratchet block 40′ engages with the ratchet ring 20′. The ball 44′ is inserted in the slant groove 45′ of the ratchet block 401. When a position of the adjustment plate 42′ is adjusted, the ratchet block 40′ will be moved. The ball 44′ should position the ratchet block 40′. When the conventional spanner 10′ is rotated with a strong force, the ball 44′ cannot position the ratchet block 40′ stably. Then the ratchet ring 20′ will rotate idly. Furthermore, the conventional spanner 10′ has many elements so that it is difficult to assemble the elements in the box head 11′.

### SUMMARY OF THE INVENTION

An object of the present invention is to provide a spanner which increases a rotational torsion of the spanner while operating.

Another object of the present invention is to provide a spanner which has a serrated block having an arc-shaped blocking face to match an arc-shaped guide wall of a box head so that a friction between the arc-shaped blocking face of the serrated block and the arc-shaped guide wall of the box head is large.

Another object of the present invention is to provide a spanner which has a serrated block and a spring presses the serrated block perpendicularly so that the serrated block can recover to an original position while operating after a long period of usage.

Accordingly, a spanner comprises a handle bar, a box head disposed on the handle bar, a ratchet ring, a C-shaped retainer, a spring, and a serrated block. The box head has an arc-shaped guide wall, an inner aperture formed on the arc-shaped guide wall, an inner groove confined by the arc-shaped guide wall, and the inner aperture communicating with the inner groove. The ratchet ring has a plurality of ratchet teeth. The serrated block has a plurality of ratchet serrations, an arc-shaped blocking face, and a blind hole. The serrated block is inserted in the inner groove of the box head. The spring has a first end inserted in the blind hole of the serrated block, and a second end inserted in the inner aperture of the box head. The C-shaped retainer surrounds the ratchet ring. The ratchet ring is inserted in the box head. The C-shaped retainer is disposed between the ratchet ring and the box head. The ratchet teeth of the ratchet ring engage with the ratchet serrations of the serrated block.

### BRIEF DESCRIPTION OF THE DRAWINGS

FIG. 1 is a perspective exploded view of a spanner of a preferred embodiment in accordance with the present invention;

FIG. 1A is a perspective view of a serrated block of a preferred embodiment in accordance with the present invention;

FIG. 2 is a perspective assembly view of a spanner of a preferred embodiment in accordance with the present invention;

FIG. 3 is a schematic view illustrating an operation of a spanner of a preferred embodiment in accordance with the present invention;

FIG. 4 is a sectional assembly view of a spanner of a preferred embodiment in accordance with the present invention;

FIG. 5 is a partially fragmental view of a spanner of a preferred embodiment in accordance with the present invention; and

FIG. 6 is a sectional view of a conventional spanner of the prior art.

### DETAILED DESCRIPTION OF THE INVENTION

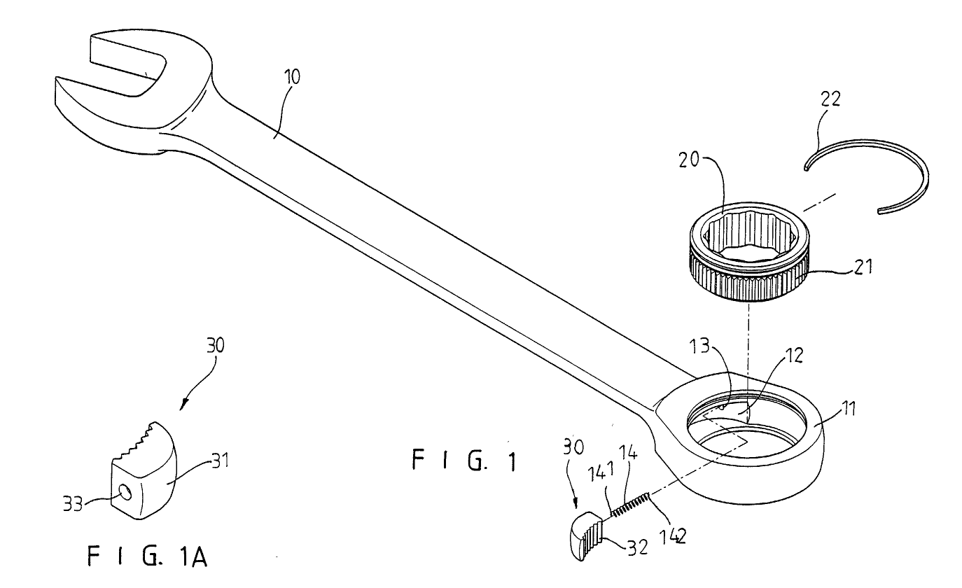

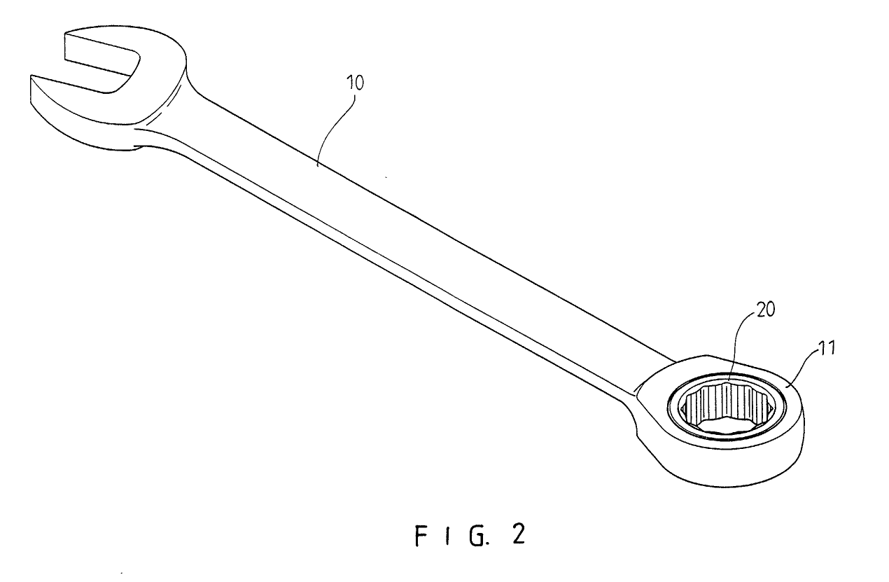

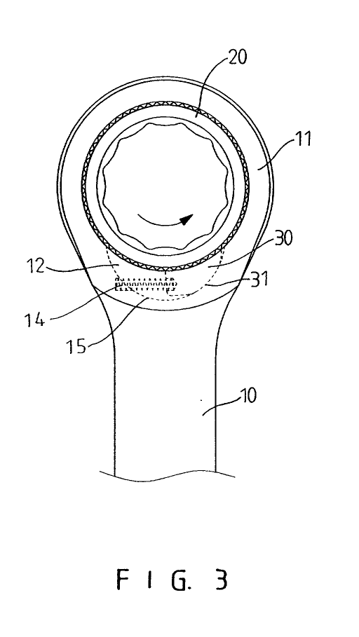

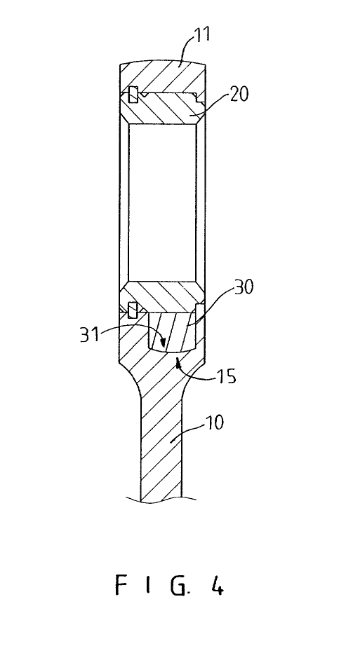

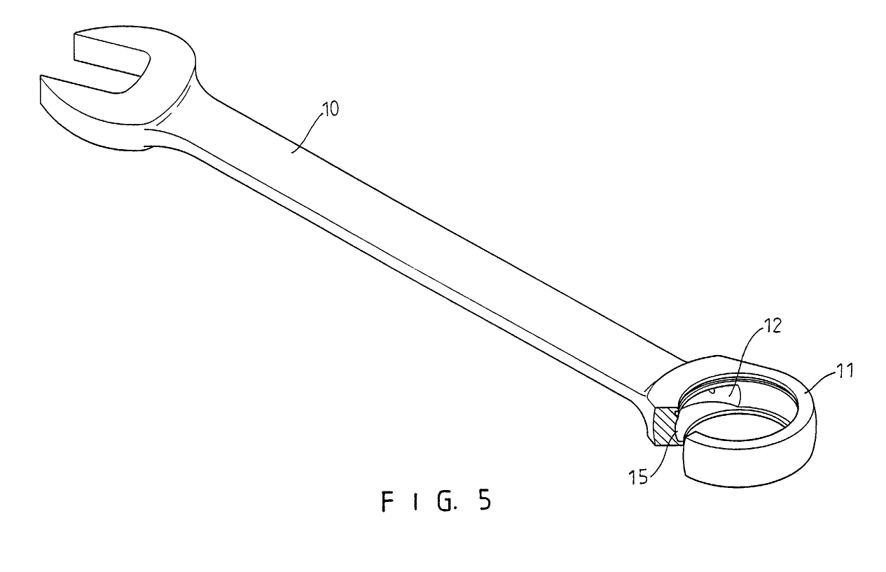

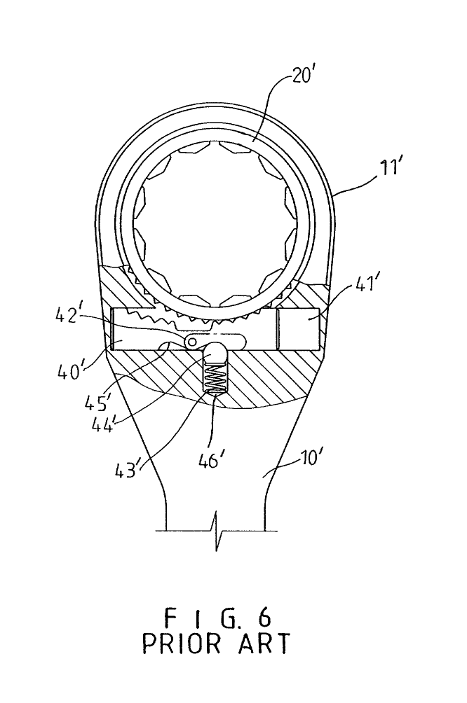

Referring to FIGS. 1 to 5, a spanner comprises a handle bar 10, a box head 11 disposed on the handle bar 10, a ratchet ring 20, a C-shaped retainer 22, a spring 14, and a serrated block 30.

The box head 11 has an arc-shaped guide wall 15, an inner aperture 13 formed on the arc-shaped guide wall 15, an inner groove 12 confined by the arc-shaped guide wall 15, and the inner aperture 13 communicating with the inner groove 12.

The ratchet ring 20 has a plurality of ratchet teeth 21.

The serrated block 30 has a plurality of ratchet serrations 32, an arc-shaped blocking face 31, and a blind hole 33.

The serrated block 30 is inserted in the inner groove 12 of the box head 11.

The spring 14 has a first end 141 inserted in the blind hole 33 of the serrated block 30, and a second end 142 inserted in the inner aperture 13 of the box head 11.

The C-shaped retainer 22 surrounds the ratchet ring 20.

The ratchet ring 20 is inserted in the box head 11.

The C-shaped retainer 22 is disposed between the ratchet ring 20 and the box head 11.

The ratchet teeth 21 of the ratchet ring 20 engage with the ratchet serrations 32 of the serrated block 30.

When the ratchet ring 20 rotates clockwise, the spring 14 will force the serrated block 30 to recover to an original position.

When the ratchet ring 20 rotates counterclockwise, the serrated block 30 will move with the ratchet ring 20 and a friction between the arc-shaped blocking face 31 of the serrated block 30 and the arc-shaped guide wall 15 of the box head 11 will be increased.

If The present invention is not limited to the above embodiment but various modification thereof may be made. Furthermore, various changes in form and detail may be made without departing from the scope of the present invention.

I claim:

1. A spanner comprises:
a handle bar, a box head disposed on the handle bar, a ratchet ring, a C-shaped retainer, a spring, and a serrated block,
the box head having an arc-shaped guide wall, an inner aperture formed on the arc-shaped guide wall, an inner groove confined by the arc-shaped guide wall, and the inner aperture communicating with the inner groove,
the ratchet ring having a plurality of ratchet teeth,
the serrated block having a plurality of ratchet serrations, an arc-shaped blocking face, and a blind hole,
the serrated block inserted in the inner groove of the box head,
the spring having a first end inserted in the blind hole of the serrated block, and a second end inserted in the inner aperture of the box head,
the C-shaped retainer surrounding the ratchet ring,
the ratchet ring inserted in the box head,
the C-shaped retainer disposed between the ratchet ring and the box head, and
the ratchet teeth of the ratchet ring engaging with the ratchet serrations of the serrated block.
